(19) United States
(12) Patent Application Publication
(10) Pub. No.: US 2014/0306455 A1
(43) Pub. Date: Oct. 16, 2014

(54) WAVE ENERGY CONVERSION SYSTEM

(71) Applicant: GREY ISLAND ENERGY INC., St. John's (CA)

(72) Inventors: Brian LUNDRIGAN, Conception Bay South (CA); Tim GARDINER, St. John's (CA)

(73) Assignee: GREY ISLAND ENERGY INC., St, John's (CA)

(21) Appl. No.: 14/247,333

(22) Filed: Apr. 8, 2014

Related U.S. Application Data
(60) Provisional application No. 61/810,463, filed on Apr. 10, 2013.

(51) Int. Cl. F03B 13/10; F03B 13/16

(52) U.S. Cl. CPC F03B 13/10; F03B 13/16
USPC 290/53

(57) ABSTRACT

A system and method comprising a first, second and third hull. An arm extending from the first hull to the second hull where the arm is coupled to a power take off module in the second hull for transferring relative motion between the second hull and the arm into electrical energy. A second arm extending from the second hull to the third hull. The second arm coupled to another power take off device in the third hull for transferring relative motion between the third hull and the second arm into electrical energy.

### FIELD OF INVENTION

The present invention relates to Wave Energy Conversion (WEC), particularly to ocean-going WEC applications.

### BACKGROUND

The capture of kinetic energy from ocean waves for transmission and use in shore-based applications is a well-known art with origins reaching as far back as the 18th century, and the conversion of that energy in-situ into electricity began in the early 20th century, although attempts to develop the technology into large-scale real world applications did not begin in earnest until the energy crisis of the mid-1970's. Ocean power represents a renewable, domestic energy source with minimal ecological impact, and so with renewed interest in so-called “green energy”—e.g., solar power, wind energy—there has been a concurrent effort of late to develop WEC as an efficient, commercializable source of power generation.

WEC applications come in a variety of shapes and forms, including some very large shore-based installations, but the two most popular formats—the Point-Absorber and the Attenuator—are based around the same core working principle: relational motion between two bodies provided by oncoming ocean waves is captured by a power take-off device and either converted directly to electricity or transmitted elsewhere for conversion. Point-Absorber systems consist of individual buoy-type devices moored to the sea-floor, and are generally designed to capture the vertical motion of the buoyant body in relation either to the stationary mooring device or a secondary subsea body. The Attenuator, on the other hand, is comprised of an articulated series of elongate, floating members, also usually moored to the ocean floor, and positioned parallel to prevailing, oncoming waves; the power take-off device in this case usually occurs between the individual members of the linear system, capturing the energy as each member moves in relation to the next member of the series. In many of these applications, the power take-off device is an hydraulic ram or series thereof, but can be any number of energy conversion methods, such as linear motors, generators, or other mechanisms for capturing such energy.

Attenuator-style applications are dependent upon the kinetic energy generated by motion between individual modules in the articulated chain and absorb this energy as waves travel down the length of the Attenuator; the more vigorous the relative motion between the modules, the more energy is absorbed by the power take-off devices. As with any buoyant body, its ability to react in any given sea state is directly linked to its total mass compared to the sea state in which it is placed. With this in mind, many Attenuator-style applications are over-built for the purposes of survivability, requiring modules comprising several buoyant members or single, massive cylinders in an articulated chain. Unfortunately in current state of the art systems as seen in FIG. 1, each member of the chain is buoyant throughout and thus the entire chain requires sufficient mass to displace enough of this buoyant force to remain stable in various sea states. Due to sheer masses involved—frequently on the order of hundreds of metric tons—the relative motion between members in the current state of the art can be dampened when operating in low sea-states and a moderate to high sea state is required for the system to respond.

This issue is illustrated in FIG. 1. Depicted in the figure are the leading trough 1, crest 2, and following trough 3 of a low sea-state wave. Here, energy would normally be absorbed by power take-offs 7A and 7B as Attenuator modules 6A and 6B are articulated upward by buoyant force 4. However, due to the system having buoyancy and mass located throughout its entirety, downward forces 5A and 5B coupled with resistance produced in power take-offs 7A and 7B make the Attenuator too rigid and heavy to react sufficiently in low sea states. Moreover, because the body of the Attenuator is opaque to the energy of the wave travelling along it, there is substantially less energy to be exerted upon the following module; that is to say, the Attenuator application as depicted literally attenuates the wave energy from which the application is intended to produce power and each following module will have less energy available to absorb. In heavy sea states, wave action is sufficiently energetic that attenuation is nearly impossible, and thus not an issue, but heavy sea states do not reflect normal day-to-day operation, and the result is a power generating installation that does not make efficient use of the energy input into the system.

Furthermore, although these overbuilt modules are individually rugged, the sheer masses involved are problematic for the survivability of the application as a whole. For example, shear strain is a pressing issue for state of the art Attenuator-style applications. This issue is illustrated in FIG. 2, which depicts a state of the art Attenuator-style application that features a plurality of buoyant members per module; even though this application has less mass than the application depicted in FIG. 1, the individual modules themselves in an Attenuator of this kind would still measure in the hundreds of tons each. The joint 8 connecting module 9 to the next module 10 will be placed under considerable shear strain as the mass of the second module 10 is pushed upwards by buoyant force 11 and the mass of the first module 9 is pushed downwards 12 by gravity. Even in a less-massive application as depicted in FIG. 2, the strain of many multiples of tons pushing on a single joint in two directions at once creates a tremendous amount of sheer force and places the entire application at risk; in an application such as is depicted in FIG. 1, where each module is considerably more massive, the strain is consequently greater, and a catastrophic breakage more likely.

It would be advantageous to overcome some of the disadvantages of the prior art.

### SUMMARY OF THE EMBODIMENTS OF THE INVENTION

In accordance with an aspect of at least one embodiment of the invention there is provided a system comprising a first hull, a second hull; a third hull; a first elongate member extending from the first hull to the second hull; the first elongate member coupled to a first power take off device in the second hull for transferring relative motion between the second hull and the first elongate member into electrical energy; a second elongate member extending from the second hull to the third hull; and the second elongate member coupled to a second power take off device in at least one of the second hull and the third hull for transferring relative motion between the third hull and the second elongate member into electrical energy.

In accordance with an aspect of at least one embodiment of the invention there is provided another system comprising a first hull other than comprising a power take off device; a fourth hull other than comprising a power take off device; a second hull comprising a first power take off device; a third hull comprising a second power take off device; a first elongate body rigidly coupled to the first hull at a first end and coupled to the first power take off device on the opposing end via a first joint, the first joint for supporting the roll, yaw and heave of the first elongate body; a second elongate body rigidly coupled to the second hull at a first end and coupled to the second power take off device on the opposing end via a second joint, the second joint for supporting the roll, yaw and heave of the second elongate body; and a third elongate body rigidly coupled to the third hull at one end and coupled to the fourth hull on the opposing end.

In accordance with an aspect of at least one embodiment of the invention there is provided a method comprising rigidly coupling a first hull to one end of a first elongated member; coupling a first power take off device to the opposing end of the first elongated member, the first power take off device enclosed in a second hull, the coupling supporting the roll, yaw and heave of the first elongated member; wherein a length of the first elongated member converts shearing forces into angular movement; generating electrical energy based on the relative motion of the first elongated member to the second hull; rigidly coupling the second hull to one end of a second elongated member; coupling a second power take off device to the opposing end of the second elongated member, the second power take off device enclosed in a third hull the coupling supporting the roll, yaw and heave of the second elongated member; wherein a length of the first elongated member converts shearing forces into angular movement; generating electrical energy based on the relative motion of the second elongated member to the third hull; and rigidly coupling one end of a third elongated device to the third hull and coupling the opposing end to a fourth hull.

### BRIEF DESCRIPTION OF THE DRAWINGS

FIG. 1 is an illustration of one type of state of the art application and attenuation of wave action.

FIG. 2 is an illustration of another type of state of the art application and shear strain at the joint.

FIG. 3 is an exploded view of an embodiment of the present invention.

FIG. 4A is an illustration depicting an embodiment of the present invention in low sea-state conditions.

FIG. 4B is another illustration depicting an embodiment of the present invention in low sea-state conditions.

FIG. 4C is an illustration depicting an embodiment of the present invention in low sea-state conditions in an inverted articulated state from FIG. 4A.

FIG. 5A is an illustration depicting wave reformation around prior art applications.

FIG. 5B is an illustration depicting wave reformation around prior art applications.

FIG. 5C is an illustration depicting wave reformation around an embodiment of the present invention.

FIG. 6 is an illustration depicting reduced shear forces on the joint sites of an embodiment of the present invention.

### DETAILED DESCRIPTION OF THE EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

An embodiment of the invention provides an improved Attenuator-style WEC design in comparison to the prior art that minimizes the amount of wave energy lost in medium to low sea states, allowing for maximum energy capture from the relative motion between two members of the articulated chain during typical day-to-day operation of the application. The embodiment decreases wave energy attenuation by providing a transparent to wave energy connecting member attached to a single buoyant member. This then better focuses the buoyancy and mass found in each discrete module of an articulated chain. In this embodiment of the present invention, wave energy passes through the connecting member, as opposed to buoying up the entire member; thus the connecting member, instead of resisting the downward pull of gravity, falls into the crest of the wave. In this way, the relative motion between members of the Attenuator is greatly increased as the chain of interconnected modules function in motion with similar properties to that of a point-absorber style device simply due to its more concentrated buoyancy and mass, resulting in maximized energy capture. This embodiment of the present invention comprises a discrete module of an articulated chain made up of a single buoyant member and a connecting member, thus maximizing the amount of wave energy captured by the application as well as minimizing shear strain at the joint. This embodiment of the invention reduces shear strain at the joint sites of the articulated chain in comparison to the prior art by reducing the number of buoyant members in each individual module of the chain to one; because each buoyant member is located at the furthest possible distance from the buoyant member of the next module and the joint connecting each member is likewise located, shear strain at the joints is minimized.

Another embodiment of the invention increases survivability of Attenuator-style applications in comparison to the prior art while providing improved power capture during low sea states. This is achieved through a design that maximizes wave energy collection by each module of the articulated chain through concentrating mass/buoyancy in key points, allowing for better articulation from the application. In addition, more efficient wave pass-through along the connecting member of each module allows for better wave reformation around each buoyant member of each module and thus more available energy can be captured, while at the same time reducing shear forces on critical components, reducing the shear strain exerted on the joints connecting the individual modules of the Attenuator.

An embodiment of the present invention increases wave energy collection in low sea states by providing a maximized unencumbered distance between hinged sections of interconnected modules. This unencumbered region is achieved via the transparent to wave energy connecting member located between buoyant members. In the present invention, wave energy is absorbed as it passes under buoyant members, however once a wave passes any buoyant member in the chain of modules the wave has been partially depleted of energy, allowing the wave to reform around the trailing end of a buoyant member. This phenomenon in effect pulls energy from a perpendicular direction to the Attenuator and into the path of the next adjoining module thus enabling the Attenuator to absorb more energy than current state of the art designs. This wave reformation again results in much greater articulation and resulting energy absorption. This embodiment can be built with significantly less material than the prior art, thereby reducing the overall mass of the application; a less-massive Attenuator means that lower wave resources are required to inspire movement and articulation between Attenuator modules thus enabling better power capture in much lower sea-states. In addition, there is great savings to be had in reduced fabrication and maintenance costs combined with a reduced need for over-built, complex mooring systems.

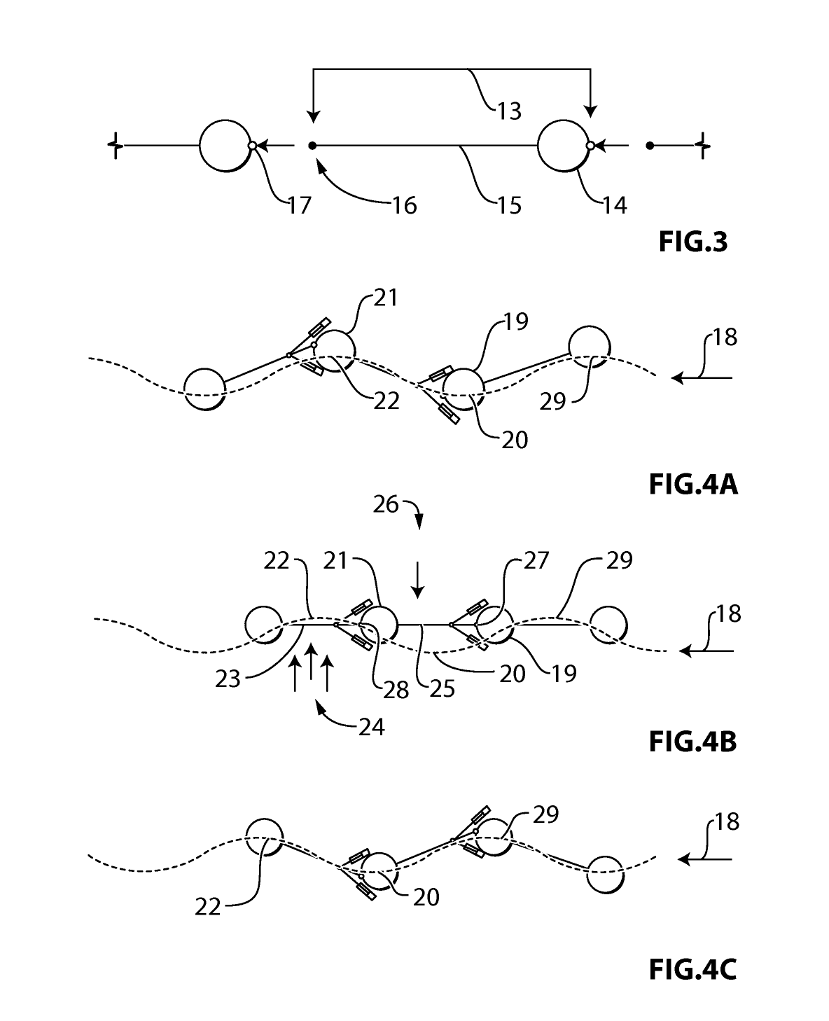

Shown in FIG. 3 is an exploded view of an embodiment of the invention. Each floating member 13 of the Attenuator is comprised of a single buoyant member 14, a connecting member 15 fixed to the buoyant member. At the terminus of the connecting member 15 is a connection point 16 that attaches to the joint 17 of the next member of the chain. A plurality of these interconnected modules formulates a completed system. Power take offs not shown in this figure would be attached to the buoyant member 14 near the joint 17 to maximize power takeoff at the point of greatest range of motion. This joint 17 and connection point 16 are depicted as external to the buoyant member, but could just as easily be located substantially within the body of the buoyant member for increased survivability. Additionally, the connecting member 15 depicted in the FIG. 3 is a simple spar. Optionally it is a rod surrounded by a truss structure. Optionally it is a mesh body with a sufficiently open weave to maximize pass-through of wave energy. Similarly, a joint optionally includes any number of joining mechanisms, dependent upon the desired ranges of motion.

Power take-off as depicted in the following embodiments occur due to vertical motion relative to the buoyant members. Other embodiments of the invention include power take-off in any number of planes and optionally involving a plurality of devices permitting movement along any number of planes as permitted by the joining mechanism.

FIG's 4 A, B and C show a simple diagram of a single wave 18 as it travels down the length of an Attenuator-type application using floating members of the embodiment of the present invention. As shown in FIG. 4A, the wave 18 travels down the length of the Attenuator, module 19 rides completely in the trough 20 of the wave 18 while the next module 21 rides at the maximum height of the wave crest 22. Maximizing the range of motion of the individual modules allows the application to take-off the most possible kinetic energy generated between the modules. The Attenuator modules are able to achieve this through concentrating buoyancy in one end of each module; this minimizes buoyant force through the length of the module and permits maximum range of motion between the modules.

Likewise, FIG. 4B shows connecting member 23 submerged in the wave crest 22; this is because the connecting member 23 is substantially transparent to wave energy, all buoyancy has been concentrated in the buoyant members as exemplified by modules 19 and 21, and thus buoyant force 24 has little effect on the connecting member 23. Similarly, because the connecting members of the Attenuator are designed for wave transparency, and are therefore of minimal mass in this embodiment, the second connecting member 25 spans the trough 20 while suffering little effect from gravity 26. These reduced masses—and resulting reduced buoyancy—not only permits pass-through of wave energy with little to no attenuation even in low sea states but also reduces the loads on the Attenuator's joints 27, 28, substantially improving the survivability of the application.

FIG. 4C shows the system in an inverted articulated state from FIG. 4A.

Instead of being buoyed upwards by the buoyant force exerted by an Attenuator application of the current state of the art, the present invention maximizes movement between two buoyant members of an Attenuator-style WEC application by maximizing pass-through of wave energy between the necessarily buoyant parts of the Attenuator. Moreover, because wave energy pass-through has been optimized, if there are additional modules beyond the minimum two necessary for a WEC application, the wave energy continues on substantially unaffected to the next module, instead of being dampened by either a relatively opaque body that spans the length of the module, or even a secondary or more buoyant body.

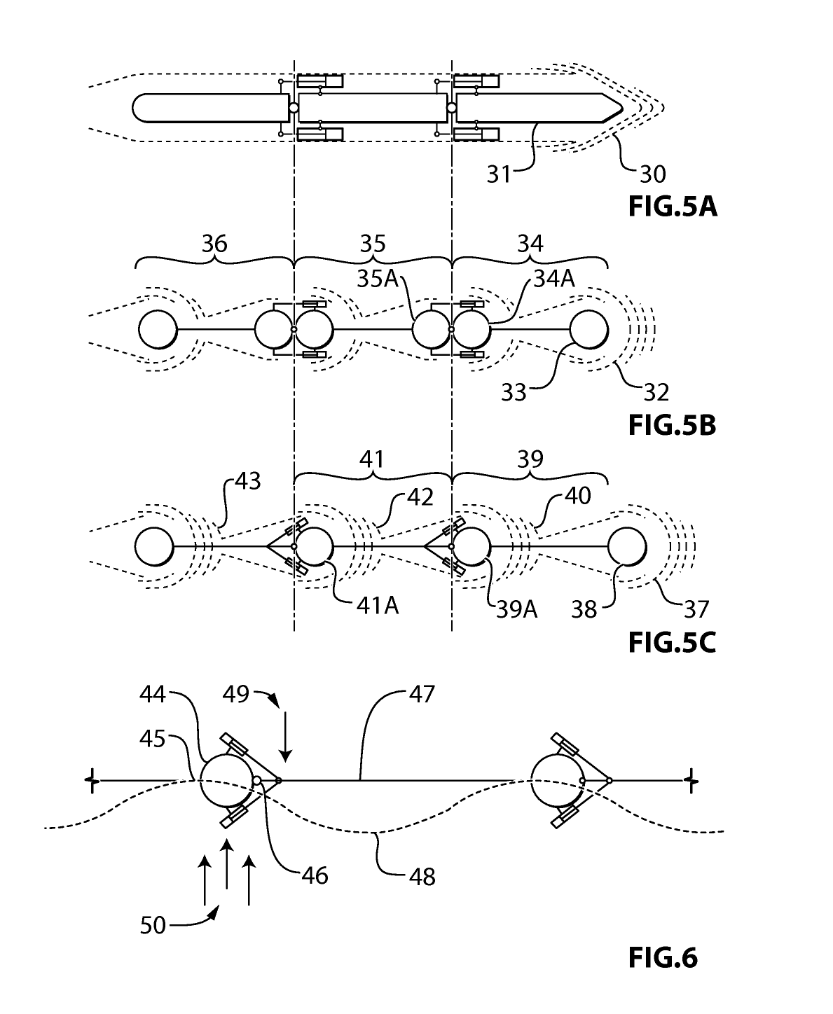

The relative effects of wave pass-through are shown in FIGs. 5A, B and C, which illustrate wave reformation around each of the Attenuator-style applications heretofore discussed.

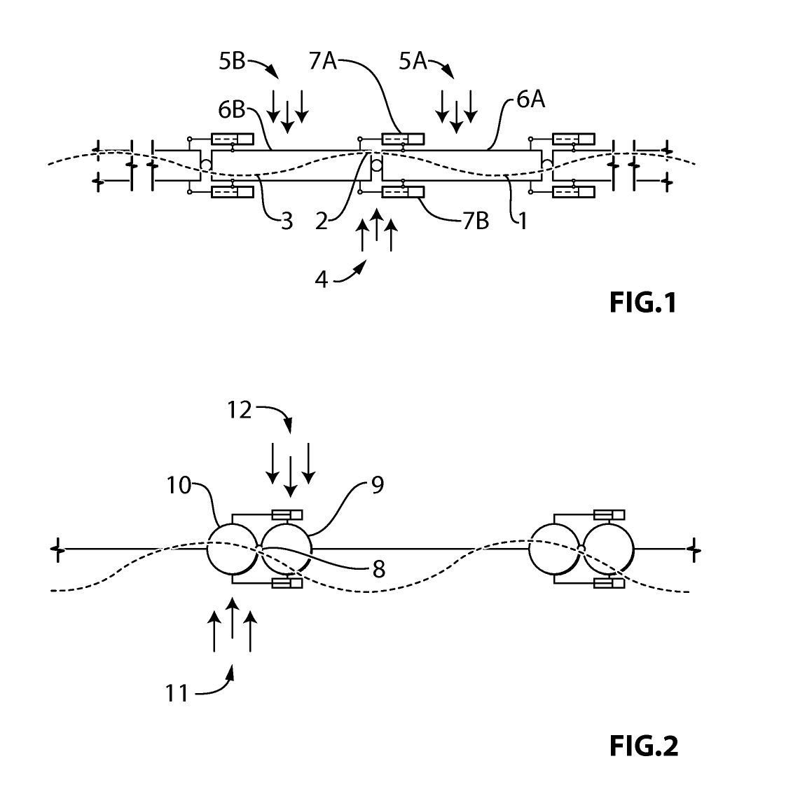

FIG. 5A shows a simple drawing of a wave 30 breaking around the bow of an Attenuator 31 of the type found in FIG. 1. The Attenuator 31 is sufficiently massive and opaque to the wave 30 that the wave travels parallel to the body of application and only reforms at the stern of the application. Unfortunately the Attenuator 31 has only removed energy running parallel with and in close proximity to the Attenuator 31 during the cycle depicted without necessarily being fully articulated. If the wave does not reform between modules, there will be a constant decrease in available wave energy and thus reduced articulation between them.

FIG. 5B shows a simple diagram of a wave 32 of the same period as that in FIG. 5A as it breaks around the bow of an Attenuator 33 of the type found in FIG. 2. In this instance, the profile of the Attenuator 33 is less opaque to wave energy than the first application 31, and the wave is permitted to reform to a greater degree than in FIG. 5A. However, the wave must break around not only the second buoyant member 34A of the first module 34, but also the first buoyant member 35A of the second module 35, and so on down the chain. With each break, the Attenuator 33 removes some energy out of the system. The crest of the wave 32 is thus substantially greater when it breaks around the bow of the Attenuator 33 than it is when it breaks around the second buoyant member 34A of the first module 34, the second module 35, or the third module 36. Thus the bow of the Attenuator 33 rides higher on the crest of the wave than the rest of the application does as the wave breaks against the subsequent modules. Significant energy is wasted in this fashion, and this style of application does not make full use of the potential energy surrounding it.

FIG. 5C is a simple diagram showing a wave 37 of the same period as that in FIGS. 5A and 5B, as it breaks around the bow of an embodiment. In this instance, the profile of the Attenuator 38 is still less opaque to wave energy than even the second application Attenuator 33. As the wave breaks around the bow of the Attenuator 38, and travels down the length of the application, the wave 37 has time to fully reform and crest in the same magnitude as the first break. As the wave 37 breaks around the buoyant member 39A of the first module 39, the wave has fully crested 40, and again as it breaks around the buoyant member 41A of the second module 41, the wave crest 42 is substantially unaffected, and reforms once more to fully crest 43 before passing the application altogether. This embodiment of the present invention's capacity for wave reformation allows the system to take full advantage of passing waves, even during low sea states; each wave crest that breaks against the buoyant member of a module has had the opportunity to fully reform and thus pull more available energy from a perpendicular direction and into the Attenuator's path.

Finally, FIG. 6 shows a simple diagram illustrating the reduction in shear strain in comparison to the prior art effected by an embodiment of the present invention. Similar to the situation depicted in FIG. 2, when a buoyant member 44 rides to the crest 45 of a wave, the joint 46 and connecting member 47 are substantially unsupported as they ride over the trough 48. However, because individual modules in the present invention have a significantly reduced mass, as compared to the state of the art, the push of gravity 49 is significantly reduced, and thus the total load, in combination with the buoyant force 50, of shear strain on the joint 46 is likewise reduced.

The embodiments presented are exemplary only and persons skilled in the art would appreciate that variations to the embodiments described above may be made without departing from the scope of the invention.

What is claimed is:

1. A system comprising
a first hull;
a second hull;
a third hull;
a first elongate member extending from the first hull to the second hull;
the first elongate member coupled to a first power take off device in the second hull for transferring relative motion between the second hull and the first elongate member into electrical energy;
a second elongate member extending from the second hull to the third hull; and
the second elongate member coupled to a second power take off device in at least one of the second hull and the third hull for transferring relative motion between the third hull and the second elongate member into electrical energy.

2. The system according to claim 1 wherein the second elongate member is coupled to a power take off device in the third hull.

3. The system according to claim 1 wherein the first elongate member and the second elongate member are substantially transparent to wave energy.

4. The system according to claim 1 comprising a fourth hull and a third elongate member extending from the third hull to the fourth hull wherein the fourth hull other than has a power take off module.

5. The system according to claim 4 wherein the third elongate member is substantially transparent to wave energy.

6. The system according to claim 1 wherein the first elongate member and the second elongate member are other than buoyant.

7. The system according to claim 4 wherein the third elongate member is other than buoyant.

8. The system according to claim 1 wherein the first elongate member and the second elongate member are disposed for other than providing buoyancy when installed and in operation.

9. The system according to claim 4 wherein the third elongate member is disposed for other than providing buoyancy when installed and in operation.

10. The system according to claim 1 wherein the first elongate member and the second elongate member comprise trusses.

11. The system according to claim 4 wherein the third elongate member comprises a truss.

12. The system according to claim 1 wherein the first elongate member is rigidly attached to the first hull.

13. The system according to claim 12 wherein the second elongate member is rigidly attached to the second hull.

14. The system according to claim 4 wherein the third elongate member is rigidly attached to the third hull.

15. The system according to claim 1 wherein the first elongate member is coupled to the first power take off device via a first joint and the second elongate member is coupled to the second power take off device via a second joint.

16. The system according to claim 15 wherein the first joint and the second joint have degrees of freedom for roll.

17. The system according to claim 15 wherein the first joint and the second joint have degrees of freedom for yaw.

18. The system according to claim 15 wherein the first joint and the second joint have degrees of freedom for heave.

19. A system comprising:
a first hull other than comprising a power take off device;
a fourth hull other than comprising a power take off device;
a second hull comprising a first power take off device;
a third hull comprising a second power take off device;
a first elongate body rigidly coupled to the first hull at a first end and coupled to the first power take off device on the opposing end via a first joint, the first joint for supporting the roll, yaw and heave of the first elongate body;
a second elongate body rigidly coupled to the second hull at a first end and coupled to the second power take off device on the opposing end via a second joint, the second joint for supporting the roll, yaw and heave of the second elongate body; and
a third elongate body rigidly coupled to the third hull at one end and coupled to the fourth hull on the opposing end.

20. A method comprising:
rigidly coupling a first hull to one end of a first elongated member;
coupling a first power take off device to the opposing end of the first elongated member, the first power take off device enclosed in a second hull, the coupling supporting the roll, yaw and heave of the first elongated member;
wherein a length of the first elongated member converts shearing forces into angular movement;
generating electrical energy based on the relative motion of the first elongated member to the second hull;
rigidly coupling the second hull to one end of a second elongated member;
coupling a second power take off device to the opposing end of the second elongated member, the second power take off device enclosed in a third hull the coupling supporting the roll, yaw and heave of the second elongated member;
wherein a length of the second elongated member converts shearing forces into angular movement;
generating electrical energy based on the relative motion of the second elongated member to the third hull; and
rigidly coupling one end of a third elongated device to the third hull and coupling the opposing end to a fourth hull.

21. The method according to claim 20 wherein the electrical energy is transferred via power cables to an electrical load.
